(19) United States
(12) Patent Application Publication
(10) Pub. No.: US 2011/0272431 A1
(43) Pub. Date: Nov. 10, 2011

(54) LIQUID DISPENSER

(75) Inventor: Jarrod Garber, Johannesburg (ZA)

(73) Assignee: JUICELOOP (PTY) LTD., Johannesburg (ZA)

(21) Appl. No.: 13/143,542

(22) PCT Filed: Jan. 8, 2010
(86) PCT No.: PCT/ZA2010/000001

§ 371 Date: Jul. 7, 2011

(30) Foreign Application Priority Data
Jan. 9, 2009 (ZA) 2008/7174

(51) Int. Cl. B67D 7/74; B67D 7/78

(52) U.S. Cl. 222/129; 222/143

(57) ABSTRACT

A liquid dispenser comprising a dispensing portion (16) integral with a storage portion (14), wherein the storage portion is releasably securable to a surface of a water container (12) of a water unit (10). The storage portion is suitably configured to enable its engagement with the water container by means of a snap-fit, alternately a slide-fit tongue and groove formation; an adhesive compound; or the suspension of storage portion from a top flange of the water container. The storage portion may comprise a resiliency depressible formation (30), which when depressed causes liquid to be dispensed from a dispensing portion.

### BACKGROUND

Liquid concentrates are commonly used to flavor water for drinking purposes. These concentrates are available in various flavors and colors, the colors usually providing some form of indication what type of flavor is contained in the particular concentrate. There are various methods of storing and dispensing the concentrate. These include simply using a screw-cap container to store the concentrate and pouring concentrate into a glass of water; to industrial size dispensing machines, which dispense metered doses of concentrate into bottles or glasses.

These storage and dispensing means, while effective have certain disadvantages. The containers or dispensing machines are often bulky and require storage space, which could be utilized by other products in the user's kitchen or pantry. In addition many of these containers are uniform in appearance and are thus difficult to locate in densely packed cupboards without unpacking and repacking the cupboard. As such these containers are often not situated or readily available when the user wants to utilize the concentrate.

Stand-alone water dispensing units (hereinafter referred to as “water units”) have become common-place in both office and home environments. These units comprise a stand portion and a water container portion. The stand comprises a recess at its top end for receiving the water container and an integral dispensing means for allowing the water to be dispensed through a tap centrally situated on the stand. The water container comprises a tubular housing having concentric spaced ribs along its longitudinal axis and a tapered outlet portion at one end, which locates into the recess of the stand, in use. Various other embodiments of the water container exist, which include variable housing shapes and rib formations. Non-limiting water container examples include generally rectangular, triangular or square shaped housing. Water containers may also have varied rib formations or the lack thereof. These rib formations may be longitudinal, vertical or angled relative to the longitudinal axis of the water container. Water units may also be enabled to refrigerate or heat the dispensed water. Further water container embodiments include containers having one or more recesses, alternately integral handles. These further features may be for aesthetic purposes as well as functional purposes.

Various products exist for storing flavorings added to water dispensed from water units. Such flavoring dispensers include containers secured to a wall proximal to the water unit and flavoring dispensers that are integral with the dispensing section of the water unit. These units are required to be refilled from another container containing the desired flavoring. This often results in flavoring being spilt and crystallized flavoring residue building up near the dispensing outlet as a result of prolonged use.

It is an object of the invention to at least partially ameliorate the abovementioned disadvantages associated with liquid storage and dispensing means.

### SUMMARY OF THE INVENTION

According to the present invention there is provided a liquid dispenser comprising a dispensing portion integral with a storage portion, wherein the storage portion is releasably securable to a surface of a water container of a water unit.

Preferably the storage portion has a channel along its rear section which is releasably securable over a rib of the water container.

Alternatively the storage portion has a rib along its rear section which is releasably securable into a suitably configured and dimensioned channel of the water container.

Conveniently the channel and ribs form a tongue and groove formation. The tongue and groove formation may engage by means of a snap-fit or a slide-fit configuration.

Conveniently the tongue and groove formation is formed along anyone of the horizontal axis, the vertical axis or at an angle between the vertical and horizontal axis of the water container, in use.

Preferably the storage portion comprises a plurality of storage sections, each section having a dispensing means. In use, a different flavoring may be stored in each section.

Alternatively the storage portion may comprise a single storage section, wherein a plurality of sections may abut one another, in use. Conveniently the storage sections may have asymmetrical perimeters.

Preferably the storage portion may comprise a flanged top portion for releasably securing over the top surface of the water container, in use.

Conveniently the storage sections abut one another vertically, alternatively horizontally relative to the longitudinal axis of the water unit.

Conveniently the storage portion comprises at least one line of weakness about its underside forming a fold-line to facilitate engaging the curved surface of the water container.

Conveniently the storage portion may have at least one extendable bellowed cross-section. The bellowed cross-section may be formed along, perpendicular or at an acute angle to the longitudinal axis of the storage portion.

Preferably the bellowed cross-section comprises a recessed channel on its underside for securing the storage portion over a rib of the water container.

Preferably an adhesive compound is used to secure the storage portion to the water container.

Preferably the adhesive compound does not leave a substantially visible or palpable residue when removed from the container, the storage portion being removable with a single pulling action, in use.

Conveniently the storage portion is at least partially transparent to evidence the color and quantity of the liquid contained therein. Alternately, the storage portion is colored to indicated the nature of the contents therein

Conveniently the dispensing portion comprises a dispensing means having a valve assembly, which when engaged dispenses the contents of the storage portion. The dispensing means may provide metered doses dispensed, alternately the quantity dispensed per dose is dependant on the duration which the valve assembly is engaged.

According to a further aspect of the invention the storage portion comprises a resiliently depressible formation and a dispensing portion, the dispensing portion remote from the formation, wherein depressing the formation causes liquid in the storage portion to be dispensed through the dispensing portion, in use. Depressing the formation causes an adequate increase in pressure in the storage portion to force liquid out the dispensing portion. Alternately depressing the formation causes the deformation of a seal of the dispensing portion.

Conveniently at least one surface of the storage portion may be depressible thereby enabling liquid to be dispensed. Alternately the depressible formation may be defined by bellow formations with a central flat portion.

Conveniently the bellows may comprise concentric rings thereby defining a button formation. Alternately the bellows may comprise at least one bellowed line of weakness at least partially surrounding a flat portion. The bellows may thus define anyone of parallel lines, two sides of a triangle or a half circle.

### BRIEF DESCRIPTION OF THE DRAWINGS

In the drawings:

FIG. 1 is a front perspective view of a liquid dispenser of the invention;

FIG. 2 is a side perspective view of a second embodiment of the liquid dispenser;

FIG. 3 is front perspective view of the liquid dispenser shown in FIG. 2;

FIG. 4 is a side perspective view of a third embodiment the liquid dispenser;

FIG. 5 is side view of the liquid dispenser shown in FIG. 4;

FIG. 6 is a perspective view of a fourth embodiment the liquid dispenser;

FIG. 7 is a side view of a fifth embodiment the liquid dispenser;

FIG. 8 is a front planar view of the liquid dispenser shown in FIG. 7;

FIG. 9 is a front planar view of a sixth embodiment the liquid dispenser having two dispensers abutting one another;

FIG. 10 is a side perspective view of a seventh embodiment of the liquid dispenser;

FIG. 11 is a side perspective view of an eighth embodiment of the liquid dispenser;

FIG. 12 is a multi-perspective view of the front and rear sides of a ninth embodiment of the liquid dispenser; and

FIG. 13 is a top perspective view of the front sides of a ninth embodiment of the liquid dispenser.

### DETAILED DESCRIPTION OF THE DRAWINGS

FIG. 1 shows a liquid dispenser 10 which is releasably securable to a water container 12 of a water unit (not shown). The dispenser comprises a liquid storage portion 14 and a dispensing portion 16. The storage portion comprises three storage sections 14.1, 14.2, 14.3 each section having a dispensing portion 16.1, 16.2, 16.3. The storage portion has a flat outer surface and inner surface shaped and configured to fit partially around the circumference of the water container.

The storage sections are generally rectangular and abut one another along their respective widths. The storage portion is deformable along its length to follow the curved profile of the water container's circumference. The inner surface of the storage portion has an adhesive layer for releasably securing the dispenser to the side surface of the water container. The adhesive is a thin translucent film which does not leave a substantially visible or palpable residue when removed from the container. The adhesive film is covered by a plastics sheet (not shown) which is peeled off prior to securing the dispenser to the water container. The plastics sheet prevents small particles attaching to the film which would otherwise reduce the adhesive capacity of the film.

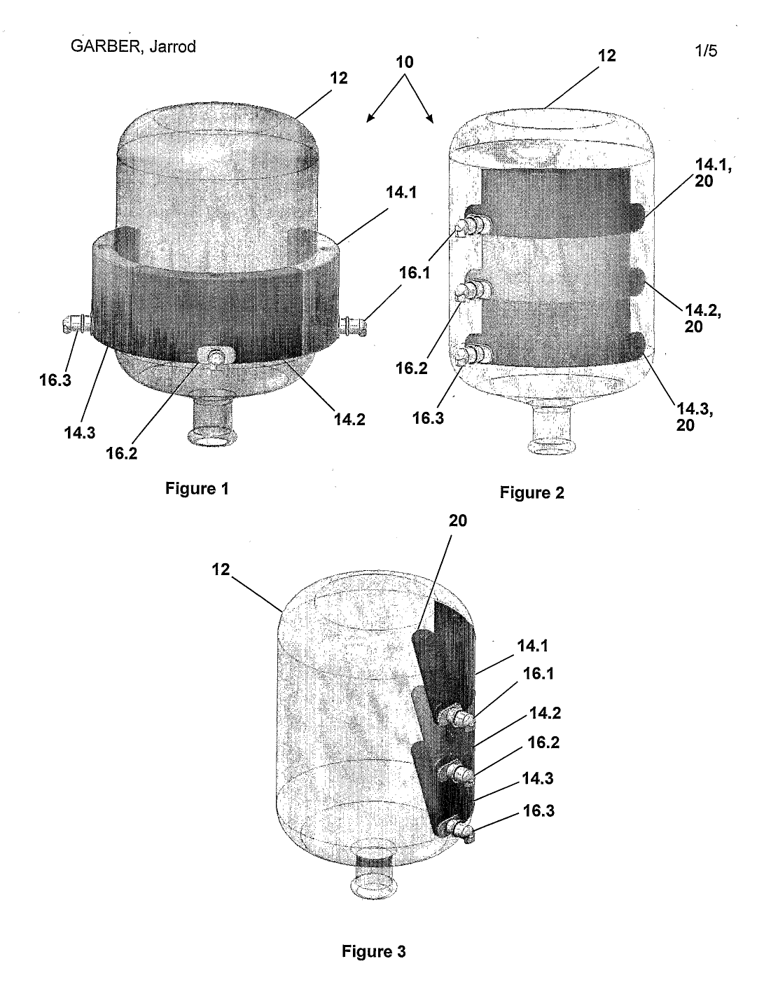

FIGS. 2 and 3 show a second embodiment of the invention wherein the storage portions are stacked vertically along the longitudinal axis of the water container. The water container has a recessed flat side wall having horizontal grooves; and the dispenser having a rear rib 20 which is receivable into the groove as tongue and groove formation. The dispensing portion of each dispenser is located on the side of the storage portion's base.

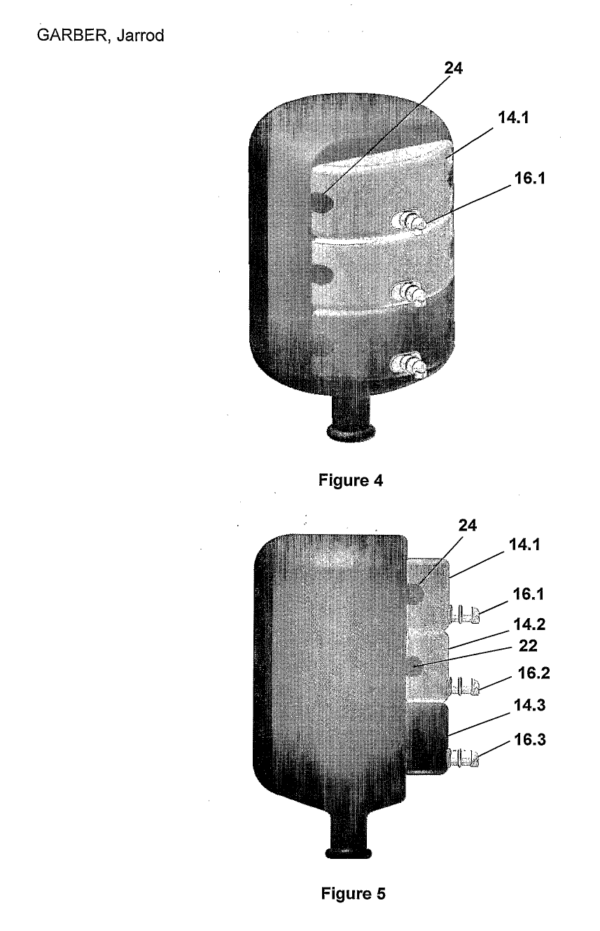

FIGS. 4 and 5 show a further embodiment of the invention, wherein the water container has a recessed flat side wall having horizontal ribs 22; and the dispenser having a rear groove 24 which is receivable over the rib as tongue and groove formation. The dispensers abut one another along the longitudinal axis of the water container. The dispensing portion of each dispenser is located centrally at the base of the storage portion.

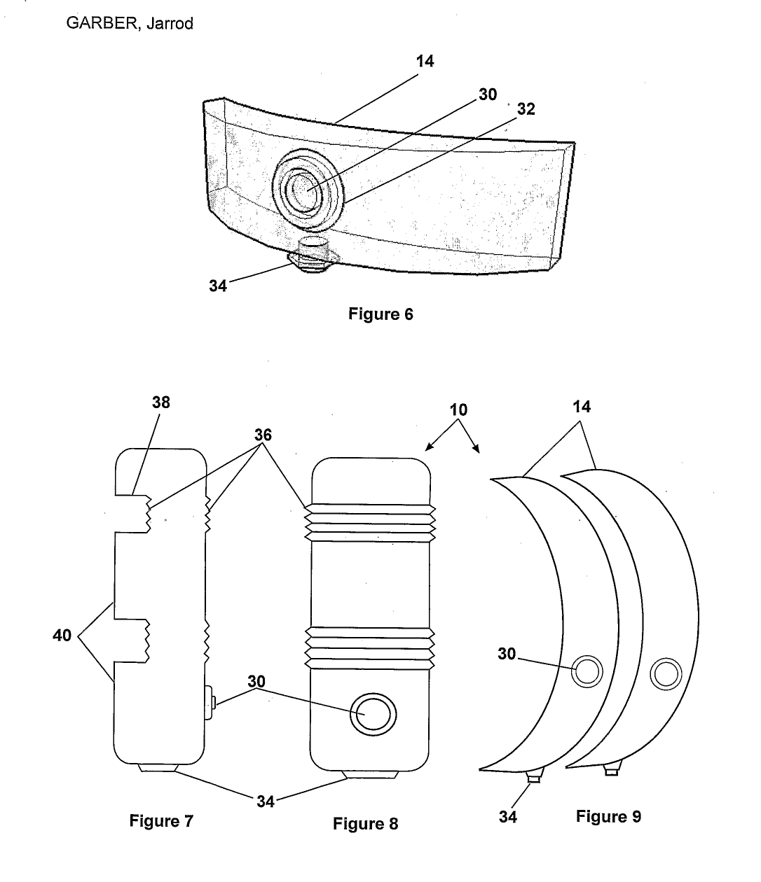

FIGS. 6 to 9 show further embodiments of the invention, wherein the storage portion comprises a resiliently depressible button formation 30 centrally located along the longitudinal axis of the said storage portion. The button is defined by a concentrically bellowed section 32. The bellows provide lines of weakness on the surface thereby enabling the button to be resiliently depressed. A dispensing aperture 34 is located at base of the storage portion. The dispensing aperture comprises a valve assembly for allowing liquid to be dispensed therethrough and air to be drawn into the storage portion, thereby maintaining the internal volume of the storage portion, in use. The inner surface of the storage portion has an adhesive layer for releasably securing the dispenser to the side surface of the water container.

FIGS. 7 and 8 show a dispenser with bellowed portions 36 about the circumference of the dispenser. The underside of the dispenser has a recessed channel 38 having its base defined by the bellowed portion. The bellowed portions are extendable thereby enabling the dispenser to be secured over water-container ribs of varying width. The non-bellowed underside 40 of the dispenser has an adhesive layer which provides the water-container engaging surface.

FIG. 9 shows an asymmetrical pair of dispensers abutting one another. In use, each dispenser may contain a different flavoring, alternately different detergents. The housing shape may vary according to aesthetic preferences.

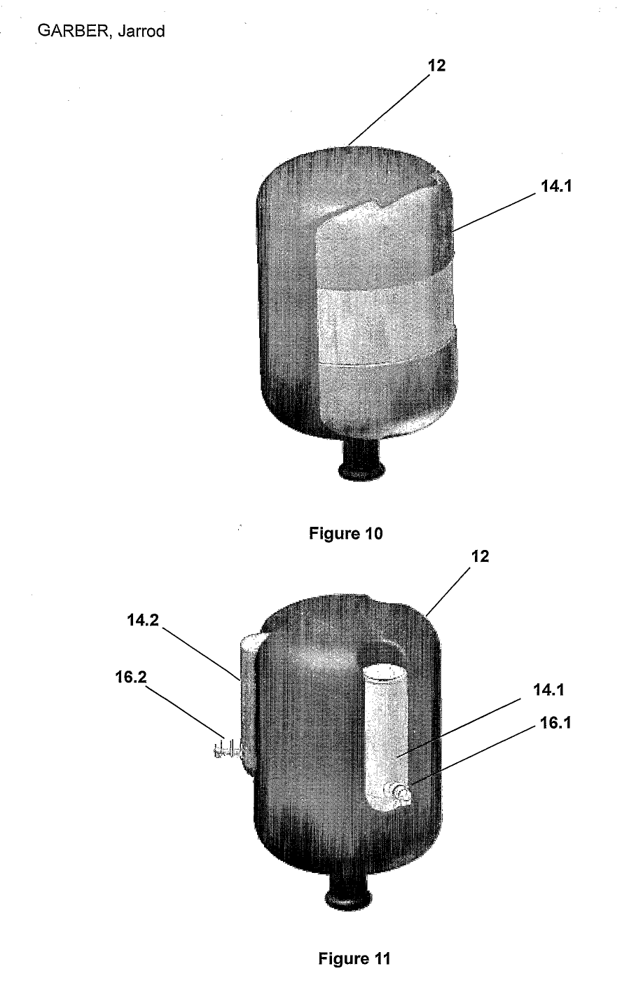

FIG. 10 shows a further embodiment wherein the water container 12 has a dove-tail tongue formation for vertical stacking of appropriately grooved and dimensioned storage portions.

FIG. 11 shows yet another embodiment wherein the water container has generally tubular grooves along the longitudinal axis of the housing 12. The grooves have an open top end and a closed base for securely receiving an appropriately shaped and dimensioned dispenser. The dispenser is received through the open end of the water container.

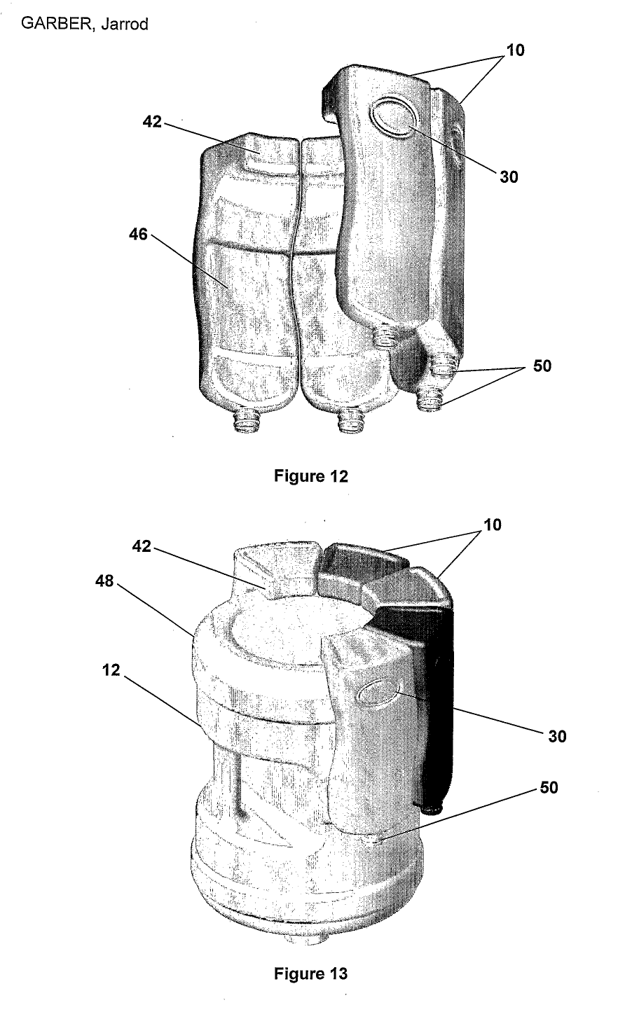

FIGS. 12 and 13 show a further embodiment of the invention having five individual storage containers circularly abutting one another about their longitudinal axis. Each storage container has a flanged top portion 42 which is releasably securable over the top portion of a water container 12 as best shown in FIG. 13. The storage container has a centrally recessed under surface 46 for accommodating and securing over a ribbed portion 48 of the water container. The storage container comprises a threaded outlet portion 50 over which a valve assembly (not shown) is screwable. A resiliently depressible button formation 30 causes liquid to be dispensed through the valve assembly when the button is depressed.

It will be appreciated that the invention is not limited to the abovementioned embodiments. For example the rib and groove formations of the water container, as the case may be, follow the longitudinal axis of the container. The dispensers are thereby vertically secured to the container. The dispenser of FIG. 1 may also be resiliently deformable to snap-fit around the water container. The dispenser as shown in FIG. 9 may also be used as a detergent dispenser which is securable on to a flat surface such as a mirror or wall and the storage portion may be any one of a variety of shapes, including symmetrical or asymmetrical shapes. The valve assembly and dispensing button used in FIGS. 12 and 13 may be replaced with a tap assembly. In a further embodiment, the storage portion may be configured to secure through a recess and around a handle formation of the water container. The storage portion may have a plurality of independent sections abutting one another horizontally, alternately vertically relative to the longitudinal axis of the storage portion.

The summary of invention and claims form an integral aspect of the description of the invention.

1-22. (canceled)

23. A liquid dispenser comprising a dispensing portion integral with a storage portion, wherein the storage portion is securable to a surface of a water container of a water unit.

24. The liquid dispenser as claimed in claim 23, wherein the storage portion has a rib along its rear section which is releasably securable into a suitably configured and dimensioned channel of the water container.

25. The liquid dispenser as claimed in claim 24, wherein the channel and ribs form a tongue and groove formation.

26. The liquid dispenser as claimed in claim 25, wherein the tongue and groove formation is formed along anyone of the horizontal axis, the vertical axis or at an angle between the vertical and horizontal axis of the water container, in use.

27. The liquid dispenser as claimed in claim 26, wherein the storage sections abut one another vertically, alternatively horizontally relative to the longitudinal axis of the water unit.

28. The liquid dispenser as claimed in claim 27, wherein the storage portion comprises a plurality of storage sections, each section having a dispensing means.

29. The liquid dispenser as claimed in claim 26, wherein the storage portion comprises a resiliently depressible formation and a dispensing portion, the dispensing portion remote from the formation; and depressing the formation causes liquid in the storage portion to be dispensed through the dispensing portion, in use.

30. The liquid dispenser as claimed in claim 29, wherein at least one surface of the storage portion is depressible thereby enabling liquid to be dispensed.

31. The liquid dispenser as claimed in claim 23, wherein the storage portion has a channel along its rear section which is releasably securable over a rib of the water container.

32. The liquid dispenser as claimed in claim 31, wherein the channel and ribs form a tongue and groove formation.

33. The liquid dispenser as claimed in claim 32, wherein the tongue and groove formation is formed along anyone of the horizontal axis, the vertical axis or at an angle between the vertical and horizontal axis of the water container, in use.

34. The liquid dispenser as claimed in claim 33, wherein the storage portion comprises a plurality of storage sections, each section having a dispensing means.

35. The liquid dispenser as claimed in claim 34, wherein the storage sections abut one another vertically, alternatively horizontally relative to the longitudinal axis of the water unit.

36. The liquid dispenser as claimed in claim 35, wherein the storage portion comprises at least one line of weakness about its underside forming a fold-line to facilitate engaging a curved surface of the water container.

37. The liquid dispenser as claimed in claim 36, wherein the storage portion comprises a resiliently depressible formation and a dispensing portion, the dispensing portion remote from the formation; and depressing the formation causes liquid in the storage portion to be dispensed through the dispensing portion, in use.

38. The liquid dispenser as claimed in claim 37, wherein at least one surface of the storage portion is depressible thereby enabling liquid to be dispensed.

39. A liquid dispenser comprising a dispensing portion integral with a storage portion, wherein the storage portion is releasably securable to a surface of a water container of a water unit, the storage portion having at least one extendable bellowed cross-section.

40. The liquid dispenser as claimed in claim 39, wherein the storage portion comprises a resiliently depressible formation and a dispensing portion, the dispensing portion remote from the formation; and depressing the formation causes liquid in the storage portion to be dispensed through the dispensing portion, in use.
